(19) United States
(12) Patent Application Publication
(10) Pub. No.: US 2026/0141220 A1
(43) Pub. Date: May 21, 2026

(54) INTELLIGENCE PROCESSING UNIT AND DEFORMABLE CONVOLUTION OPERATION METHOD

(71) Applicant: Sigmastar Technology Ltd., Xiamen (CN)

(72) Inventors: Yongsheng Chen, Shanghai (CN); Yu Xia, Shanghai (CN); Linhao Zhang, Shanghai (CN); Houyu Wang, Shanghai (CN)

(21) Appl. No.: 19/360,277

(22) Filed: Oct. 16, 2025

(30) Foreign Application Priority Data
Nov. 19, 2024 (CN) 202411662078.X

(51) Int. Cl. G06N 3/0464

(52) U.S. Cl. CPC G06N 3/0464

(57) ABSTRACT

An intelligence processing unit (IPU) includes a memory, a grid processing circuit, and a convolution computation circuit. The memory is configured to store a part of a first input data of a deformable convolution operation, a part of a bias of the deformable convolution operation, a part of a weight of the deformable convolution operation, and a part of a grid, where the grid is transformed from an offset of the deformable convolution operation. The grid processing circuit is configured to perform a grid-sample operation to generate a second input data based on the first input data and the grid. The convolution computation circuit is configured to perform a convolution operation on the second input data, the weight, and the bias to generate an output data. The output data is substantially equal to the result of the deformable convolution operation.

This application claims the benefit of China application Serial No. CN 202411662078.X, filed on Nov. 19, 2024, the subject matter of which is incorporated herein by reference.

### BACKGROUND OF THE INVENTION

### 1. Field of the Invention

The present invention generally relates to convolution operations, and more particularly, to an operation method of deformable convolution.

### 2. Description of Related Art

Deformable convolution is a type of convolution. FIG. 1 is a schematic diagram of the conventional deformable convolution. The deformable convolution operator 100 performs operations on the deformable convolution input data DAT (e.g., the feature map), the weight KER (also known as the convolution kernel), the offset OST, the mask MSK, and the bias BIS to generate the output data Dout. The offset OST is used to indicate the correspondence between the deformable convolution output data Dout and the deformable convolution input data DAT. The operational details of deformable convolution are well known to people having ordinary skill in the art, so further elaboration is omitted for brevity. It should be noted that in some applications, the mask MSK does not exist.

The existing technology uses a central processing unit (CPU) or a graphic processing unit (GPU) to perform the computation of deformable convolution. However, because the CPU and the GPU are not circuits specifically designed for the computation of deformable convolution, the computational efficiency is not good. Furthermore, because the cost of the CPU and the GPU is relatively high, they are not suitable for low-cost embedded systems.

### SUMMARY OF THE INVENTION

In view of the issues of the prior art, an object of the present invention is to provide an intelligence processing unit (IPU) and an operation method of deformable convolution, so as to make an improvement to the prior art.

According to one aspect of the present invention, an IPU is provided. The IPU includes a memory, a grid processing circuit, and a convolution computation circuit. The memory stores a part of a first input data of a deformable convolution operation, a part of a bias of the deformable convolution operation, a part of a weight of the deformable convolution operation, and a part of a grid, where the grid is transformed from an offset of the deformable convolution operation. The grid processing circuit, coupled to the memory, performs a grid-sample operation to generate a second input data based on the first input data and the grid. The convolution computation circuit, coupled to the memory, performs a convolution operation on the second input data, the weight, and the bias to generate an output data. The output data is substantially equal to a result of the deformable convolution operation.

According to another aspect of the present invention, an operation method of deformable convolution is provided. The operation method, executed on an IPU, includes the following steps: executing a grid-sample operation to generate a second input data based on a grid and a first input data of a deformable convolution operation, where the grid is obtained by transforming an offset of the deformable convolution operation; and performing a convolution operation on the second input data, a weight of the deformable convolution operation, and a bias of the deformable convolution operation to generate an output data. The output data is substantially equal to a result of the deformable convolution operation.

The technical means embodied in the embodiments of the present invention can solve at least one of the problems of the prior art. Therefore, compared to the prior art, the present invention can improve efficiency and reduce costs.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a schematic diagram of the conventional deformable convolution.

FIG. 2 is a circuit diagram of an electronic device according to an embodiment of the present invention.

FIG. 3 is a schematic diagram of a deformable convolution operation according to an embodiment of the present invention.

FIG. 4 is a schematic diagram of a deformable convolution operation according to another embodiment of the present invention.

FIG. 5 is a flowchart for transforming an offset into a grid according to an embodiment of the present invention.

FIG. 6 is the flowchart of the constant provision step S530 of FIG. 5 according to an embodiment.

FIG. 7 shows a segment of code written in the C language for generating constants.

FIG. 8 is a schematic diagram of the deformable convolution operation according to another embodiment of the present invention.

FIG. 9 is a flowchart of the grid-sample operation according to an embodiment of the present invention.

FIG. 10 is a schematic diagram of the input and output of the grid-sample operator according to the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an intelligence processing unit (IPU) and an operation method of deformable convolution. On account of that some or all elements of the IPU could be known, the detail of such elements is omitted provided that such detail has little to do with the features of this disclosure, and that this omission nowhere dissatisfies the specification and enablement requirements. Some or all of the processes of the operation method of deformable convolution may be implemented by software and/or firmware and can be performed by the IPU or its equivalent. A person having ordinary skill in the art can choose components or steps equivalent to those described in this specification to carry out the present invention, which means that the scope of this invention is not limited to the embodiments in the specification.

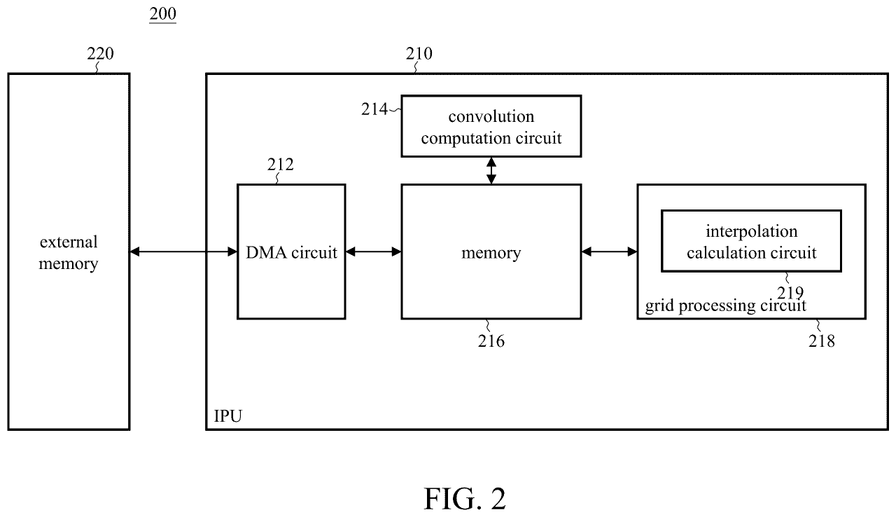

FIG. 2 is a circuit diagram of an electronic device according to an embodiment of the present invention. The electronic device 200 includes an IPU 210 and an external memory 220 that are coupled to each other. The IPU 210 includes a direct memory access (DMA) circuit 212, a convolution computation circuit 214, a memory 216, and a grid processing circuit 218, all of which are coupled to each other. The grid processing circuit 218 includes an interpolation calculation circuit 219.

The external memory 220 stores data related to deformable convolution computation, such as the deformable convolution input data DAT, the weight KER, the offset OST, the mask MSK (if any), and the bias BIS.

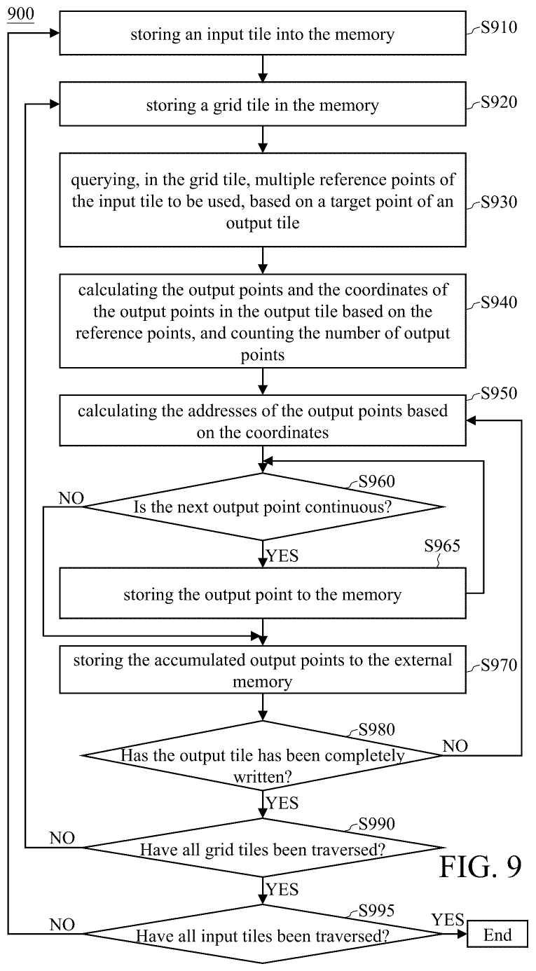

This invention uses the grid processing circuit 218 to perform a grid-sample operation to transform the deformable convolution input data DAT of the deformable convolution into the input data DAT2 of a general convolution (i.e., non-deformable convolution, such as two-dimensional convolution or three-dimensional convolution) (to be discussed in detail below with reference to FIG. 9). The details of the grid-sample operation are well known to people having ordinary skill in the art. Relevant content can at: be referenced pytorch.org/docs/stable/generated/torch.nn.functional.grid_sample.html.

The DMA circuit 212 is coupled between the memory 216 and the external memory 220 and is configured to read data from the external memory 220 and then write the read data into the memory 216, or to read data from the memory 216 and then write the read data into the external memory 220. Since the capacity of the memory 216 is usually much smaller than the capacity of the external memory 220, the deformable convolution input data DAT, the weight KER, the offset OST, and the bias BIS are often divided into multiple tiles for convolution operations. The division of data into multiple tiles is well known to people having ordinary skill in the art, so further elaboration is omitted for brevity. During actual operation, the memory 216 stores at least one tile of the deformable convolution input data DAT, at least one tile of the weight KER, at least one tile of the offset OST, and at least one tile of the bias BIS.

The convolution computation circuit 214 is used to perform general (i.e., non-deformable) convolution operations (e.g., two-dimensional convolution operations or three-dimensional convolution operations), and stores the result of the convolution operation (i.e., the output data Dout) into the memory 216.

The interpolation calculation circuit 219 performs interpolation calculations based on the interpolation coefficients generated by the grid processing circuit 218. In some embodiments (for illustration purposes only, not intended to limit the invention), the interpolation calculation circuit 219 operates based on the bilinear interpolation or the nearest-neighbor interpolation.

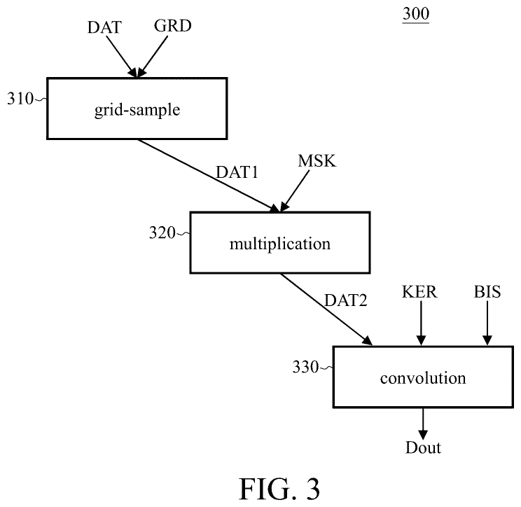

Reference is made to FIG. 3, which is a schematic diagram of the deformable convolution operation according to an embodiment of the present invention. The deformable convolution operation 300 (i.e., the operation method of deformable convolution) includes the grid-sample operator 310 (i.e., the grid-sample operation), the multiplication operator 320 (i.e., the multiplication operation), and the convolution operator 330 (i.e., the convolution operation). The convolution operator 330 is general convolution, not deformable convolution. The grid-sample operator 310 and the multiplication operator 320 are executed by the grid processing circuit 218. The convolution operator 330 is executed by the convolution computation circuit 214.

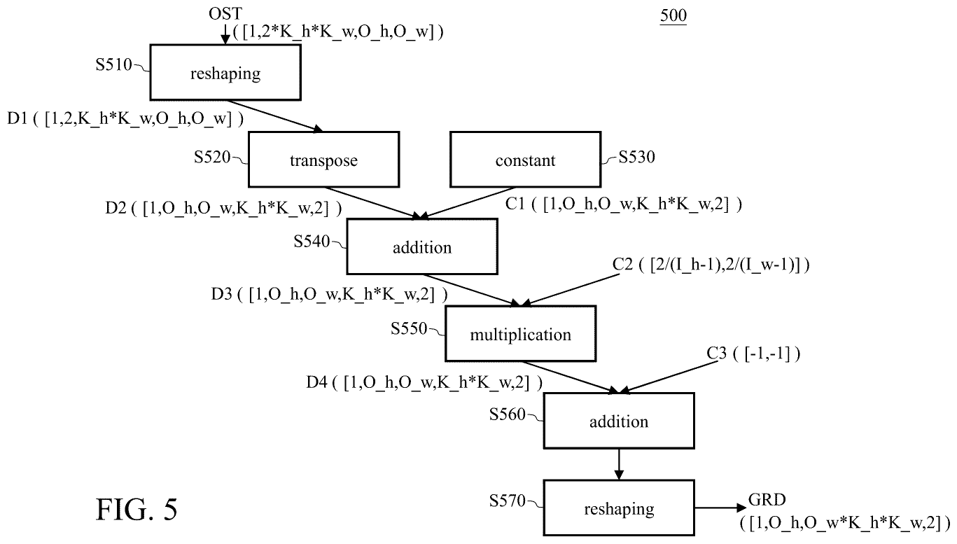

The input of the grid-sample operator 310 is the deformable convolution input data DAT and the grid GRD. The grid GRD specifies the correspondence between the output data Dout and the deformable convolution input data DAT. More specifically, the grid GRD specifies the correspondence between a certain point (coordinate) of the output data Dout and a certain point (coordinate) of the deformable convolution input data DAT. The offset OST can be transformed into the grid GRD based on the attribute parameters of the deformable convolution (which will be detailed below with reference to FIG. 5). If the offset OST is a constant, then the grid GRD is also a constant. The grid-sample operator 310 transforms the deformable convolution input data DAT into the intermediate data DAT1 according to the grid GRD.

The multiplication operator 320 multiplies the intermediate data DAT1 with the mask MSK to generate the general convolution input data DAT2. The convolution operator 330 performs a general convolution operation (e.g., a two-dimensional convolution operation or a three-dimensional convolution operation) on the general convolution input data DAT2, the weight KER, and the bias BIS to generate the output data Dout. The multiplication operator 320 and the convolution operator 330 are well known to people having ordinary skill in the art, so further elaboration is omitted for brevity.

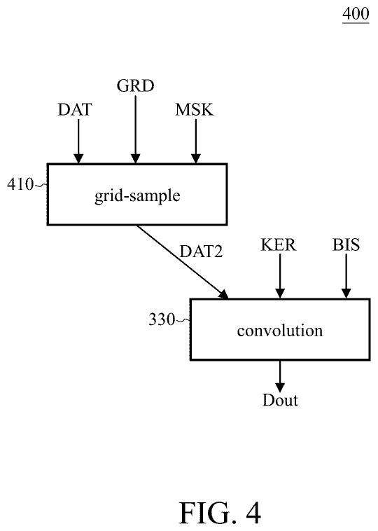

Reference is made to FIG. 4, which is a schematic diagram of the deformable convolution operation according to another embodiment of the present invention. The deformable convolution operation 400 includes the grid-sample operator 410 and the convolution operator 330. The grid-sample operator 410 transforms the deformable convolution input data DAT into the general convolution input data DAT2 based on the grid GRD and the mask MSK. That is to say, the deformable convolution operation 400 is similar to the deformable convolution operation 300, where the operation of the grid-sample operator 410 is equivalent to the combination of the operation of the grid-sample operator 310 and the operation of the multiplication operator 320.

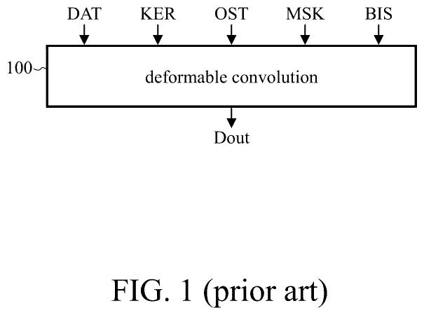

The output data Dout in FIGS. 3 and 4 is substantially the same as the output data Dout of the deformable convolution operator 100 in FIG. 1.

Reference is made to FIG. 5, which is a flowchart for transforming the offset OST into the grid GRD according to an embodiment of the present invention. The data dimensions shown in FIG. 5 are used for illustration only and are not intended to limit the present invention. In the example of FIG. 5, K_h, K_w, O_h, O_w, I_h, and I_w respectively represent the height of the weight KER, the width of the weight KER, the height of the output data Dout, the width of the output data Dout, the height of the deformable convolution input data DAT, and the width of the deformable convolution input data DAT.

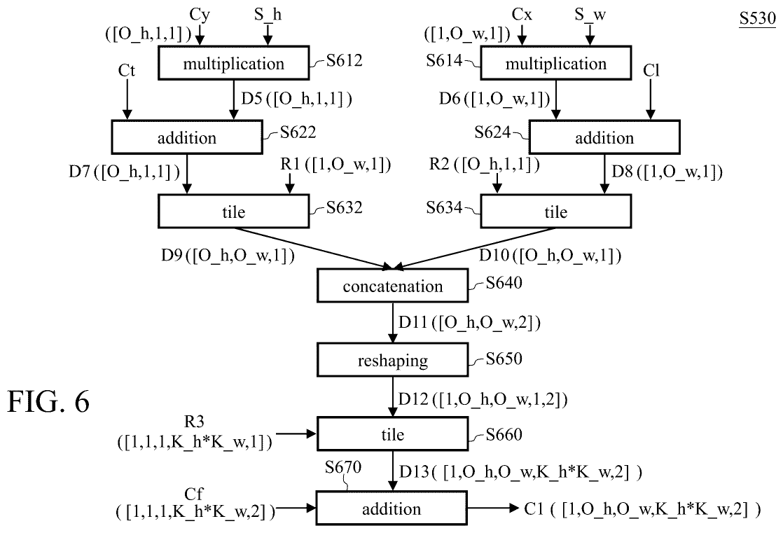

The transformation process 500 can be executed by the grid processing circuit 218 and includes the following steps. The reshaping step S510 reshapes the offset OST (with dimensions: [1,2*K_h*K_w,O_h,O_w]) into the data D1 (with dimensions: [1,2,K_h*K_w,O_h,O_w]). The transpose step S520 transposes the data D1 into the data D2 (with dimensions: [1,O_h,O_w,K_h*K_w,2]). The constant provision step S530 provides the constant C1 (with dimensions: [1,O_h,O_w,K_h*K_w,2]). Step S530 will be detailed below with reference to FIG. 6. The addition step S540 adds the data D2 to the constant C1, generating the data D3 (with dimensions: [1,O_h,O_w,K_h*K_w,2]). The multiplication step S550 multiplies the data D3 with the constant C2 (with dimensions: [2/(I_h−1),2/(I_w−1)]), generating the data D4 (with dimensions: [1,O_h,O_w,K_h*K_w,2]). The addition step S560 adds the data D4 to the constant C3 (with dimensions: [−1,−1]), then the reshaping step S570 reshapes the result of step S560 into the grid GRD (with dimensions: [1,O_h,O_w*K_h*K_w,2]).

In some embodiments, only when the offset OST is a variable, the IPU 210 (more specifically, the grid processing circuit 218) executes the transformation process 500 of FIG. 5. On the contrary, when the offset OST is a constant, the transformation process 500 of FIG. 5 can be performed in advance on a development device (e.g., a general computer). In this case, the grid GRD can be pre-stored in the memory 216, and the IPU 210 does not need to execute the process of FIG. 5.

Reference is made to FIG. 6, which is the flowchart of the constant provision step S530 in FIG. 5 and includes the following steps according to an embodiment. The multiplication step S612 multiplies the step length S_h by the constant Cy (with dimensions: [O_h,1,1]), generating the data D5 (with dimensions: [O_h,1,1]). The multiplication step S614 multiplies the step length S_w with the constant Cx (with dimensions: [1,O_w,1]), generating the data D6 (with dimensions: [1,O_w,1]). The step length S_h and the step length S_w are respectively the step lengths in height and width when the weight KER slides over the deformable convolution input data DAT. The constant Cy and the constant Cx are shown in equations (1) and (2), respectively.

$$C y = \{ 0 , 1 , … , O\_h - 1 \} \qquad ( 1 )$$

$$Cx = \{ 0 , 1 , … , O\_w - 1 \} \qquad ( 2 )$$

The addition step S622 adds the data D5 to the constant Ct, generating the data D7 (with dimensions: [O_h,1,1]). The addition step S624 adds the data D6 to the constant Cl, generating the data D8 (with dimensions: [1,O_w,1]). The constant Ct and the constant Cl are shown in Equations (3) and (4), respectively.

$$Ct = ( K\_h - 1 ) / 2 * D\_h - Pt \qquad ( 3 )$$

$$Cl = ( K\_w - 1 ) / 2 * D\_w - Pl \qquad ( 4 )$$

where D_h and D_w are the dilation factors of the weight KER in height and width, respectively, while Pt and Pl are the padding values of the deformable convolution input data DAT on the top and left sides, respectively.

The tile step S632 copies the data D7 according to the parameter R1 (with dimensions: [1,O_w, 1]), generating the data D9 (with dimensions: [O_h,O_w,1]). The tile step S634 copies the data D8 according to the parameter R2 (with dimensions: [O_h,1,1]), generating the data D10 (with dimensions: [O_h,O_w,1]). The tile operation includes copying data to expand the tensor in one or more dimensions, and it is well known to people having ordinary skill in the art, so further elaboration is omitted for brevity.

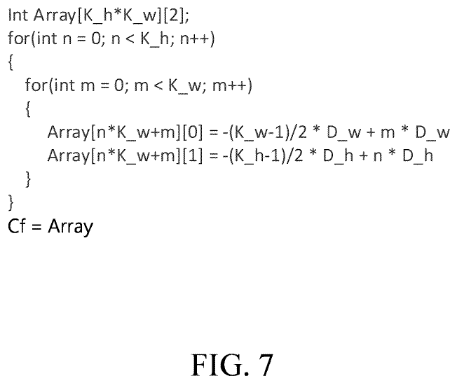

The concatenation step S640 concatenates the data D9 and the data D10, generating the data D11 (with dimensions: [O_h,O_w,2]). The reshaping step S650 reshapes the data D11, generating the data D12 (with dimensions: [1,O_h,O_w,1,2]). The tile step S660 copies the data D12 according to the parameter R3 (with dimensions: [1,1,1,K_h*K_w,1]), generating the data D13 (with dimensions: [1,O_h,O_w,K_h*K_w,2]). The addition step S670 adds the data D13 to the constant Cf, generating the constant C1. The constant Cf is a matrix, the contents of which are shown in FIG. 7. FIG. 7 shows a segment of code written in the C language for generating the constant Cf. This segment of code is well known to people having ordinary skill in the art, so further elaboration is omitted for brevity.

In some embodiments, the process of FIG. 6 can be completed in advance on a development device. That is to say, the constant C1 can be pre-stored in the memory 216, thus the IPU 210 does not need to perform the process of FIG. 6.

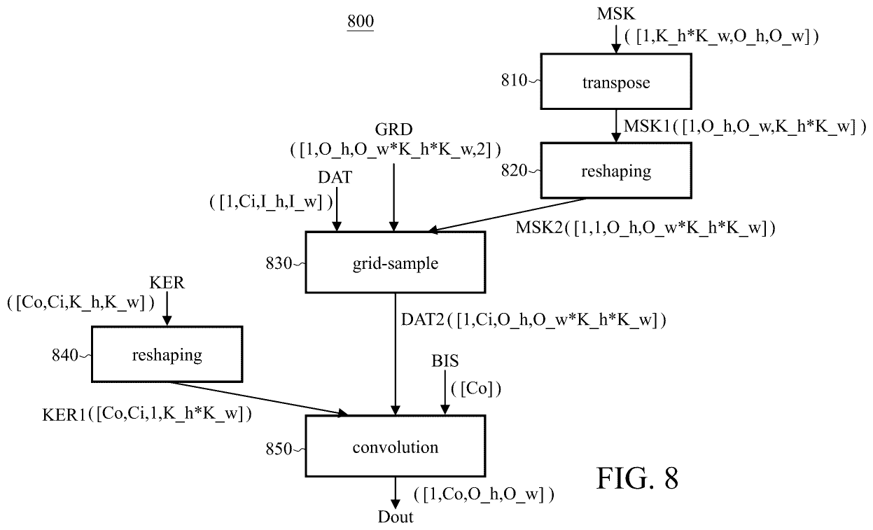

Reference is made to FIG. 8, which is a schematic diagram of the deformable convolution operation according to another embodiment of the present invention. Compared to the deformable convolution operation 400, the deformable convolution operation 800 shows more details. The data dimensions shown in FIG. 8 are used for illustration only and are not intended to limit the present invention. In the example of FIG. 8, Ci and Co respectively represent the channel numbers of the deformable convolution input data DAT and the output data Dout of the deformable convolution, and the meanings represented by the rest of the symbols are the same as those in FIG. 5.

The deformable convolution operation 800 includes the transpose operator 810, the reshaping operator 820, the grid-sample operator 830, the reshaping operator 840, and the convolution operator 850.

The transpose operator 810 transposes the mask MSK (with dimensions: [1,K_h*K_w,O_h,O_w]) into the MSK1 mask (with dimensions: [1,O_h,O_w,K_h*K_w]). The reshaping operator 820 reshapes the mask MSK1 into the mask MSK2 (with dimensions: [1,1,O_h,O_w*K_h*K_w]). In some embodiments, if the mask MSK does not exist, the transpose operator 810 and the reshaping operator 820 can be omitted.

The grid-sample operator 830 transforms the deformable convolution input data DAT (with dimensions: [1,Ci,I_h,I_w]) into the general convolution input data DAT2 (with dimensions: [1,Ci,O_h,O_w*K_h*K_w]) based on the grid GRD (with dimensions: [1,O_h,O_w*K_h*K_w,2]) and the mask MSK2 (if applicable).

The reshaping operator 840 (executed by the DMA circuit 212) reshapes the weight KER (with dimensions: [Co, Ci,K_h,K_w]) into the weight KER1 (with dimensions: [Co, Ci, 1, K_h*K_w]).

The convolution operator 850 is a general convolution, not a deformable convolution. The convolution operator 850 performs a general convolution operation on the general convolution input data DAT2 (with dimensions: [1,Ci,O_h,O_w*K_h*K_w]), the weight KER1 (with dimensions: [Co,Ci, 1,K_h*K_w]), and the bias BIS (with dimensions: [Co]), generating the output data Dout (with dimensions: [1,Co,O_h,O_w]).

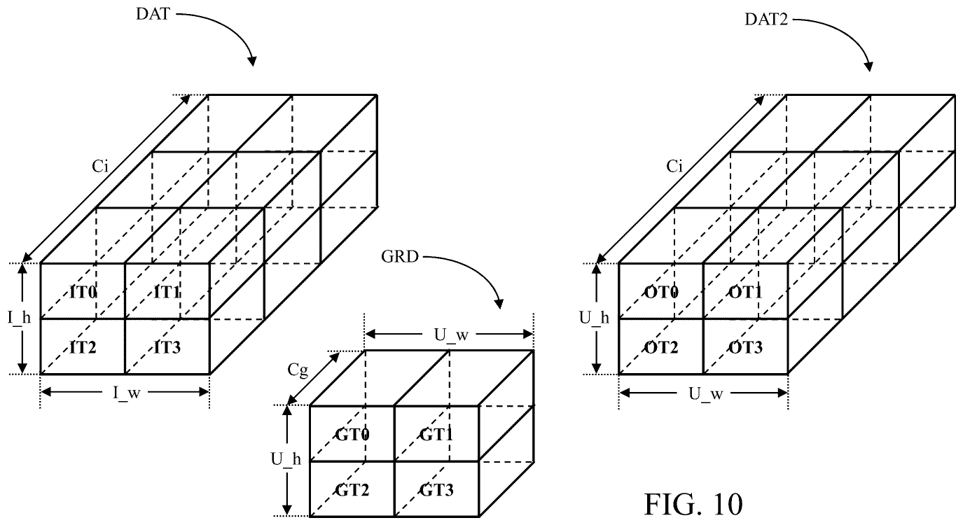

Reference is made to FIG. 9 and FIG. 10. FIG. 9 is a flowchart of the grid-sample operation according to an embodiment of the present invention. FIG. 10 is a schematic diagram of the input (the deformable convolution input data DAT and the grid GRD) and the output (the general convolution input data DAT2) of the grid-sample operator of the present invention. The height, width, and number of channels of the general convolution input data DAT2 are U_h, U_w, and Ci, respectively, while the height, width, and number of channels of the grid GRD are U_h, U_w, and Cg, respectively. The number of channels Cg represents the number of coordinates of a point. For example, when the number of channels Cg is 2 (or 3), a point corresponds to 2 (or 3) coordinates (i.e., two-dimensional coordinates (or three-dimensional coordinates)). In the embodiment of FIG. 10, the deformable convolution input data DAT includes four tiles (IT0, IT1, IT2, IT3), the grid GRD includes four tiles (GT0, GT1, GT2, GT3), and the general convolution input data DAT2 includes four tiles (OT0, OT1, OT2, OT3). The number of tiles is only used for illustration, not to limit the invention.

The grid-sample operation 900 can correspond to the grid-sample operator 310, the grid-sample operator 410, or the grid-sample operator 830, and includes the following steps.
Step S910: The DMA circuit 212 reads a tile of the deformable convolution input data DAT (hereinafter referred to as the input tile) from the external memory 220 and stores the input tile into the memory 216.
Step S920: The DMA circuit 212 reads a tile of the grid GRD (hereinafter referred to as a grid tile) from the external memory 220 and stores the grid tile in the memory 216.
Step S930: The grid processing circuit 218 queries, in the grid tile, multiple reference points of the input tile to be used, based on a target point of an output tile, which is a tile of the general convolution input data DAT2. More specifically, in the height-width plane, each point of the general convolution input data DAT2 corresponds one-to-one with each point of the grid GRD, and one point in the grid GRD points to one point on the height-width plane of the deformable convolution input data DAT. For example, if the target point is the top-left corner point of the output tile OT0, the grid processing circuit 218 queries a coordinate from the corresponding position of the grid GRD (e.g., the top-left corner of the grid tile GT0) based on the target point. Next, the grid processing circuit 218 finds an initial reference point corresponding to the coordinate on the height-width plane of the deformable convolution input data DAT according to the coordinate and then uses all points (a total of Ci points) corresponding to the initial reference point in the channel dimension as the reference points.
Step S940: The grid processing circuit 218 calculates the output points (i.e., a part of the general convolution input data DAT2) and the coordinates of the output points in the output tile based on the reference points, and counts the number of output points. More specifically, in step S940, the grid processing circuit 218 generates the interpolation coefficients and transmits them to the interpolation calculation circuit 219. The interpolation calculation circuit 219 performs interpolation on the reference points based on the interpolation coefficients to calculate the output points.
Step S950: The grid processing circuit 218 calculates the addresses of the output points in the external memory 220 based on the coordinates of the output points in the output tile.
Step S960: The grid processing circuit 218 determines whether the next output point is continuous. The grid processing circuit 218 determines, according to the grid GRD, whether the deformable convolution input data DAT (i.e., the reference points) corresponding to the output points has been stored in the memory 216. Because the memory 216 does not simultaneously store the deformable convolution input data DAT, but only stores one of the input tiles (step S910), the reference points may exist in the memory 216 (i.e., the input tile(s) to which the reference points belong is/are stored in the memory 216, hereinafter referred to as condition (1)) or may not exist in the memory 216 (i.e., the input tile(s) to which the reference points belong is/are not stored in the memory 216, hereinafter referred to as condition (2)). Therefore, if the reference points corresponding to the next output point are not in the memory 216 (condition (2)), then the result of the step S960 is NO. Conversely, if the reference points corresponding to the next output point are in the memory 216 (condition (1)), then the result of step S960 is YES. The grid processing circuit 218 continuously performs step S960 and step S965 until the result is NO.
Step S965: The grid processing circuit 218 stores the output point to the memory 216, that is, the grid processing circuit 218 accumulates the output points in the memory 216.
Step S970: The DMA circuit 212 stores the accumulated output points (including the current output point) to the external memory 220.
Step S980: The grid processing circuit 218 determines whether the current output tile has been completely written to the external memory 220. If NO, then the flow proceeds to step S950; if YES, then the flow proceeds to step S990.
Step S990: The grid processing circuit 218 determines whether all grid tiles (i.e., the grid tiles GT0 to GT3) have been traversed. If NO, then the flow proceeds to step S920; if YES, then the flow proceeds to step S995.
Step S995: The grid processing circuit 218 determines whether all input tiles (i.e., the input tiles IT0 to IT3) have been traversed. If NO, then the flow proceeds to step S910; if YES, then the flow ends.

Steps S950 to S980 are the steps for storing the output tiles. By accumulating the output points that are continuous in memory addresses, the DMA circuit 212 can continuously write out the output data, avoiding fragmented access to the external memory 220. This can improve the efficiency of writing data by the DMA circuit 212 and save memory bandwidth.

The flowchart in FIG. 9 includes an outer loop (steps S910 to S995) and an inner loop (steps S920 to S990). The outer loop is for processing the input tiles, while the inner loop is for processing the grid tiles. That is to say, each grid tile will be loaded into the memory 216 multiple times, because every time an input tile is processed, all the grid tiles will be sequentially loaded into the memory 216. Because the data amount of the grid tiles is smaller than that of the input tiles, such a process consumes less memory bandwidth (compared to when the inner loop processes the input tiles and the outer loop processes the grid tiles).

For the deformable convolution operation 300 in FIG. 3, in step S940, the grid processing circuit 218 first performs interpolation calculation (the grid-sample operator 310), and then multiplies the interpolated result by the mask MSK (the multiplication operator 320). For the deformable convolution operation 400 in FIG. 4 and the deformable convolution operation 800 in FIG. 8, in step S940, the grid processing circuit 218 first multiplies the interpolation coefficient by the mask MSK to generate a product, and then performs interpolation calculation based on the product (the grid-sample operator 410 or the grid-sample operator 830). Therefore, compared to the deformable convolution operation 300, the deformable convolution operation 400 and the deformable convolution operation 800 can reduce the amount of computation and computation time.

In summary, by decomposing the deformable convolution operation into the grid-sample operation and the general convolution operation, the execution efficiency of the deformable convolution operation can be improved (including, but not limited to, reducing the bandwidth requirement for external memory), and the operation can be executed by a relatively low-cost application-specific integrated circuit (ASIC), such as an IPU.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An intelligence processing unit (IPU), comprising:
a memory configured to store a part of a first input data of a deformable convolution operation, a part of a bias of the deformable convolution operation, a part of a weight of the deformable convolution operation, and a part of a grid, wherein the grid is transformed from an offset of the deformable convolution operation;
a grid processing circuit coupled to the memory and configured to perform a grid-sample operation to generate a second input data based on the first input data and the grid; and
a convolution computation circuit coupled to the memory and configured to perform a convolution operation on the second input data, the weight, and the bias to generate an output data;
wherein the output data is substantially equal to a result of the deformable convolution operation.

2. The IPU of claim 1, wherein the offset is a variable, and the grid processing circuit further performs a transformation process to transform the offset into the grid.

3. The IPU of claim 2, wherein the transformation process comprises following steps:
reshaping the offset to generate a first data;
transposing the first data to generate a second data;
adding a first constant to the second data to generate a third data;
multiplying the third data by a second constant to generate a fourth data; and
adding a third constant to the fourth data to generate an intermediate result, and reshaping the intermediate result to generate the grid.

4. The IPU of claim 1, wherein the convolution computation circuit performs a reshaping operation on the weight before executing the convolution operation.

5. The IPU of claim 1, wherein the memory stores an input tile of the first input data and a grid tile of the grid, and the grid processing circuit performs following steps to generate the second input data:
querying, in the grid tile according to a target point of the second input data, a plurality of reference points of the input tile to be used; and
calculating an output point of the second input data and a coordinate of the output point according to the plurality of reference points.

6. The IPU of claim 5, wherein the grid processing circuit comprises an interpolation calculation circuit performing an interpolation calculation based on an interpolation method to generate the output point.

7. The IPU of claim 6, wherein the grid processing circuit generates an interpolation coefficient, and the interpolation calculation circuit multiplies the interpolation coefficient by a mask of the deformable convolution operation to generate a product and performs the interpolation calculation based on the product.

8. The IPU of claim 5, wherein the IPU is coupled to an external memory, the grid processing circuit further performs following steps:
calculating an address of the output point in the external memory according to the coordinate; and
storing the output point to the external memory when a next output point of the output point is discontinuous with the output point in the external memory.

9. The IPU of claim 5, wherein the IPU is coupled to an external memory, the grid processing circuit further performs following steps:
calculating an address of the output point in the external memory according to the coordinate; and
storing the output point to the memory when a next output point of the output point is continuous with the output point in the external memory.

10. An operation method of deformable convolution executed on an intelligence processing unit (IPU) and comprising:
executing a grid-sample operation to generate a second input data based on a grid and a first input data of a deformable convolution operation, wherein the grid is obtained by transforming an offset of the deformable convolution operation; and
performing a convolution operation on the second input data, a weight of the deformable convolution operation, and a bias of the deformable convolution operation to generate an output data;
wherein the output data is substantially equal to a result of the deformable convolution operation.

11. The operation method of claim 10, wherein the offset is a variable, and the operation method further comprises:
executing a transformation process to transform the offset into the grid.

12. The operation method of claim 11, wherein the transformation process comprises following steps:
reshaping the offset to generate a first data;
transposing the first data to generate a second data;
adding a first constant to the second data to generate a third data;
multiplying the third data by a second constant to generate a fourth data; and
adding a third constant to the fourth data to generate an intermediate result, and reshaping the intermediate result to generate the grid.

13. The operation method of claim 10 further comprising:
performing a reshaping operation on the weight before performing the convolution operation.

14. The operation method of claim 10, wherein the first input data comprises an input tile, the grid comprises a grid tile, and the operation of generating the second input data comprises following steps:
querying, in the grid tile according to a target point of the second input data, a plurality of reference points of the input tile to be used; and
calculating an output point of the second input data and a coordinate of the output point according to the plurality of reference points.

15. The operation method of claim 14 further comprising:
performing an interpolation calculation based on an interpolation method to generate the output point.

16. The operation method of claim 15 further comprising:
multiplying an interpolation coefficient by a mask of the deformable convolution operation to generate a product; and
performing the interpolation calculation based on the product.

17. The operation method of claim 14, wherein the IPU is coupled to an external memory, and the operation method further comprises:
calculating an address of the output point in the external memory according to the coordinate; and
storing the output point to the external memory when a next output point of the output point is discontinuous with the output point in the external memory.

18. The operation method of claim 14, wherein the IPU comprises a memory and is coupled to an external memory, and the operation method further comprises:
calculating an address of the output point in the external memory according to the coordinate; and
storing the output point to the memory when a next output point of the output point is continuous with the output point in the external memory.
